(19) United States
(12) Patent Application Publication
(10) Pub. No.: US 2012/0167269 A1
(43) Pub. Date: Jul. 5, 2012

(54) APRON FOR STORING HEATED HAIR CARE APPLIANCES

(76) Inventor: Nicole Hernandez, North Las Vegas, NV (US)

(21) Appl. No.: 12/983,091

(22) Filed: Dec. 31, 2010

(51) Int. Cl. A41D 13/04; A62D 5/00; A62B 17/00

(52) U.S. Cl. 2/50; 2/458

(57) ABSTRACT

An apron for storing heated hair care appliances comprising a body panel of material comprising a fabric sheet; at least one strap attached to the body panel; and a heat resistant pocket attached to a front side of the body panel, in which the body panel covers the torso of a user, in which the strap secures the body panel to the torso of a user, in which the heat resistant pocket comprises a fabric sheet and at least one heat resistant material for storing heated hair care appliances in the body panel, in which the heat resistant pocket has a square, rectangular, circular, triangular, or hexagonal shape, in which the heat resistant pocket comprises an open top portion and an open bottom portion, in which the open bottom portion comprises at least one zipper, at least one clasp, at least one button, or at least one fastener for closing the open bottom portion, and in which the heat resistant pocket comprises at least two side members securely attached to the body panel.

### BACKGROUND OF THE INVENTION

The disclosure generally relates to protective garments, specifically to heat resistant receptacles, including aprons with pockets, for storing heated hair care appliances.

Current designs for aprons or various garments or holding devices are not useful in the cosmetology field as there is no place capable of safely housing a hair care device or tool that emits thermal energy. Thus, there is a need for an apron having an insulated pocket with heat resistance for temporary placement of a heated hair care appliance.

The present disclosure provides an apron for storing heated hair care appliances that includes, without limitation, a body panel of material comprising a fabric sheet; at least one strap attached to the body panel; and a heat resistant pocket attached to a front side of the body panel.

Further, the body panel covers the torso of a user, the strap secures the body panel to the torso of a user, the heat resistant pocket comprises a fabric sheet and at least one heat resistant material for storing heated hair care appliances in the body panel, the heat resistant pocket has a square, rectangular, circular, triangular, or hexagonal shape, the heat resistant pocket comprises an open top portion and an open bottom portion, the open bottom portion comprises at least one zipper, at least one clasp, at least one button, or at least one fastener for closing the open bottom portion, and the heat resistant pocket comprises at least two side members securely attached to the body panel.

The apron of the present disclosure effectively protects a user from heat and external burns or heat related injuries resulting from contact with a heated hair care appliance.

### BRIEF SUMMARY OF THE INVENTION

In accordance with the disclosure, the apron for storing heated hair care appliances comprises a body panel of material comprising a fabric sheet; at least one strap attached to the body panel; and a heat resistant pocket attached to a front side of the body panel, in which the body panel covers the torso of a user, in which the strap secures the body panel to the torso of a user, in which the heat resistant pocket comprises a fabric sheet and at least one heat resistant material for storing heated hair care appliances in the body panel, in which the heat resistant pocket has a square, rectangular, circular, triangular, or hexagonal shape, in which the heat resistant pocket comprises an open top portion and an open bottom portion, in which the open bottom portion comprises at least one zipper, at least one clasp, at least one button, or at least one fastener for closing the open bottom portion, and in which the heat resistant pocket comprises at least two side members securely attached to the body panel.

In another aspect of the disclosure, the invention provides a heat resistant receptacle comprising a heat resistant pocket attached to a front side of an apron, in which the apron covers the torso of a user, in which the heat resistant pocket comprises a fabric sheet and at least one heat resistant material for storing heated hair care appliances in the body panel, in which the heat resistant pocket has a square, rectangular, circular, triangular, or hexagonal shape, in which the heat resistant pocket comprises an open top portion and an open bottom portion, in which the open bottom portion comprises at least one zipper, at least one clasp, at least one button, or at least one fastener for closing the open bottom portion, and in which the heat resistant pocket comprises at least two side members securely attached to the body panel.

Other objects will be apparent from the following description of the drawings and embodiments of the invention.

### BRIEF DESCRIPTION OF THE DRAWINGS

FIG. 1 is a plain view of the apron for storing heated hair care appliances; and

FIG. 2 is a plain view of the heat resistant receptacle or pocket.

### DETAILED DESCRIPTION OF THE INVENTION

A more complete appreciation of the disclosure and many of the attendant advantages will be readily obtained, as the same becomes better understood by reference to the following detailed description when considered in connection with the accompanying drawings.

The term “apron” generally relates to and is understood to include a full apron, a bib apron, a waist apron, a skirt, a jumper, a combination thereof, and any fabric used to cover or protect the torso of a user.

The term “heated hair care appliance” generally includes but is not limited to electrical and/or mechanical devices for hair care and hair styling that emit thermal energy.

The term “heat resistant receptacle” generally relates to and is understood to include a pocket, a holder, a pouch, a bag, a sack, a cavity, a container, an enclosed space, or any attachment forming part of a garment that is used to hold or carry small objects.

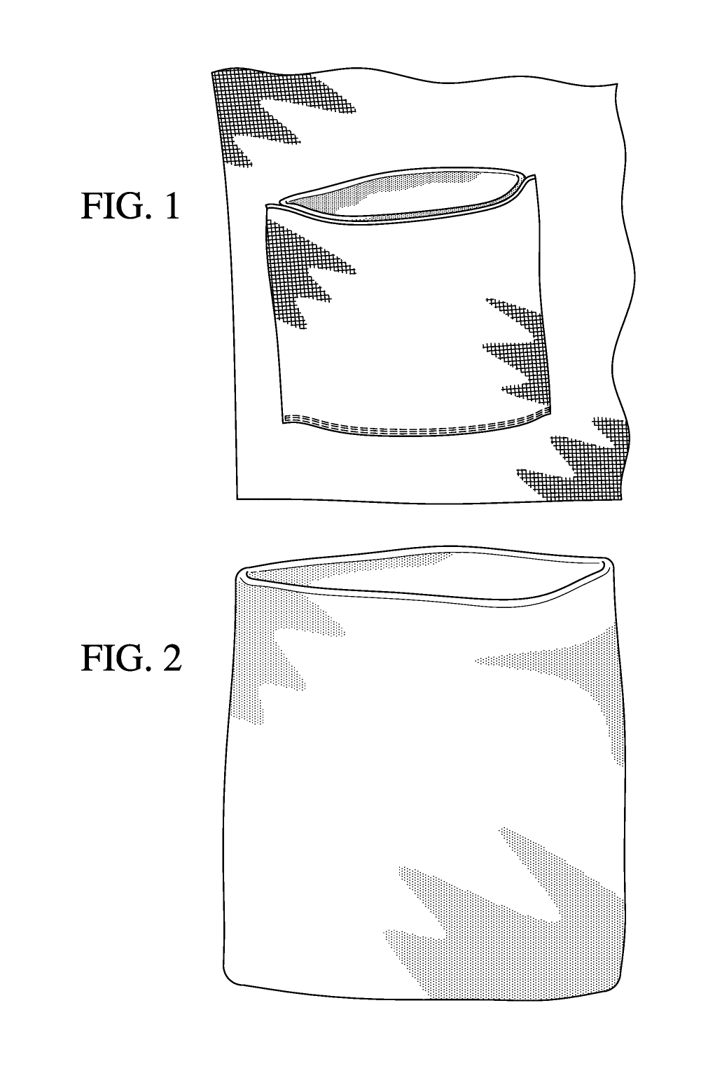

As shown in FIG. 1, the apron for storing heated hair care appliances is illustrated.

In a preferred embodiment, the illustration shows and the disclosure provides an apron for storing heated hair care appliances comprising a body panel of material comprising a fabric sheet; at least one strap attached to the body panel; and a heat resistant pocket attached to a front side of the body panel, in which the body panel covers the torso of a user, in which the strap secures the body panel to the torso of a user, in which the heat resistant pocket comprises a fabric sheet and at least one heat resistant material for storing heated hair care appliances in the body panel, in which the heat resistant pocket has a square, rectangular, circular, triangular, or hexagonal shape, in which the heat resistant pocket comprises an open top portion and an open bottom portion, in which the open bottom portion comprises at least one zipper, at least one clasp, at least one button, or at least one fastener for closing the open bottom portion, and in which the heat resistant pocket comprises at least two side members securely attached to the body panel.

In another embodiment, the heat resistant material protects the torso from heat and external burns from any heated hair care appliance stored in the apron or heat resistant receptacle. Specifically, the heat resistant material protects the user from direct burns to clothing or skin while the device is stored in the apron or heat resistant receptacle.

In a preferred embodiment, the heat resistant material is scorch proof to about 500 degrees Fahrenheit (° F.). In another preferred embodiment, the heat resistant material is scorch proof from about 450° F. to about 500° F.

The heat resistant material may include but is not limited to a wide range of fibers, fabrics, and cloths. In a preferred embodiment, the heat resistant material comprises a silicone rubber coated fiberglass.

In a preferred embodiment, the heat resistant material comprises fibers or polymeric material. In another preferred embodiment, the fibers comprise melamine, aramids, para-aramids, or a combination thereof. In another preferred embodiment, the polymeric material is a modacrylic polymer.

The heat resistant material may also include cotton or fibers treated with a flame retardant.

In a preferred embodiment, the heat resistant material comprises glass insulation and foil scrim encased in a thermal heat resistant, flame retardant fabric.

In further embodiments, the heat resistant material is a heat-resistant fiber yarn formed of at least one selected from the group consisting of an aramid fiber, a polybenzimidazole fiber, a polybenzoxazole fiber, a polybenzthiazole fiber, a polyamide imide fiber, a melamine fiber, a polyimide fiber, a polyarylate fiber, and a carbon fiber.

In a preferred embodiment, the fabric sheet is formed of a material comprising a double knit, a double jersey, an interlock knit fabric, a double raschel, a double knitted fabric, a double cloth, a single knit, a smooth knitted fabric, or a combination thereof.

In a preferred embodiment, the heated hair care appliances may include a hair roller, a flat iron, a curling iron, a hair dryer, a blow dryer, a crimping iron, a hot comb, an electric shaver, a pair of tongs, a styling brush, a scalp massager, and combinations thereof.

In a preferred embodiment, the heat resistant pocket is positioned at a hip area of the torso. However, the heat resistant pocket may be positioned at any location on an apron or suitable garment that covers or protects the torso of a user.

In a preferred embodiment, the size of the heat resistant pocket is about 4 to 10 inches in width and about 6 to 12 inches in depth. In another preferred embodiment, the size of the heat resistant pocket is about 4 to 6 inches in width and 6 to 8 inches in depth. In another preferred embodiment, the size of the heat resistant pocket is about 8 to 10 inches in width and about 10 to 12 inches in depth.

In another preferred embodiment, the heat resistant pocket is stitched or sewn on the sides. In further embodiments, the heat resistant pocket may be stapled, buckled, glued or secured on the sides to an apron or other suitable garment by any conventional method of attachment.

In a preferred embodiment, the apron is a full apron or half apron generally worn by cosmetologists or hair stylists in the course of washing, drying, perming, curling, and styling hair.

FIG. 2 illustrates the heat resistant receptacle or pocket of the disclosure.

In a preferred embodiment, the illustration shows and the disclosure provides a heat resistant receptacle comprising a heat resistant pocket attached to a front side of an apron, in which the apron covers the torso of a user, in which the heat resistant pocket comprises a fabric sheet and at least one heat resistant material for storing heated hair care appliances in the body panel, in which the heat resistant pocket has a square, rectangular, circular, triangular, or hexagonal shape, in which the heat resistant pocket comprises an open top portion and an open bottom portion, in which the open bottom portion comprises at least one zipper, at least one clasp, at least one button, or at least one fastener for closing the open bottom portion, and in which the heat resistant pocket comprises at least two side members securely attached to the body panel.

In more detail, the heat resistant receptacle has a square or rectangular shape and protects the torso from heat and external burns from a heated hair care appliance.

In more detail, the heat resistant material has a scorch proof to 500° F.

Obviously, numerous modifications and variations of the disclosure are possible in light of the above disclosure. It is therefore understood that within the scope of the appended claims, the disclosure may be practiced otherwise than as specifically described herein.

What is claimed as new and desired to be protected by Letters Patent of the United States is:

1. An apron for storing heated hair care appliances comprising:
a body panel of material comprising a fabric sheet; at least one strap attached to the body panel; and a heat resistant pocket attached to a front side of the body panel,
wherein the body panel covers the torso of a user,
wherein the strap secures the body panel to the torso of a user,
wherein the heat resistant pocket comprises a fabric sheet and at least one heat resistant material for storing heated hair care appliances in the body panel,
wherein the heat resistant pocket has a square, rectangular, circular, triangular, or hexagonal shape,
wherein the heat resistant pocket comprises an open top portion and an open bottom portion,
wherein the open bottom portion comprises at least one zipper, at least one clasp, at least one button, or at least one fastener for closing the open bottom portion, and
wherein the heat resistant pocket comprises at least two side members securely attached to the body panel.

2. The apron according to claim 1, wherein the heat resistant material protects the torso from heat and external burns from a heated hair care appliance.

3. The apron according to claim 1, wherein the heat resistant material is scorch proof to about 500° F.

4. The apron according to claim 1, wherein the heat resistant material comprises a silicone rubber coated fiberglass.

5. The apron according to claim 1, wherein the heat resistant material comprises fibers or polymeric material.

6. The apron according to claim 5, wherein the fibers comprise melamine, aramids, para-aramids, or a combination thereof.

7. The apron according to claim 5, wherein the polymeric material is a modacrylic polymer.

8. The apron according to claim 1, wherein the heat resistant material comprises cotton or fibers treated with a flame retardant.

9. The apron according to claim 1, wherein the heat resistant material comprises glass insulation and foil scrim encased in a thermal heat resistant, flame retardant fabric.

10. The apron according to claim 1, wherein the heat resistant material is a heat-resistant fiber yarn formed of at least one selected from the group consisting of an aramid fiber, a polybenzimidazole fiber, a polybenzoxazole fiber, a polybenzthiazole fiber, a polyamide imide fiber, a melamine fiber, a polyimide fiber, a polyarylate fiber, and a carbon fiber.

11. The apron according to claim 1, wherein the fabric sheet is formed of a material comprising a double knit, a double jersey, an interlock knit fabric, a double raschel, a double knitted fabric, a double cloth, a single knit, a smooth knitted fabric, or a combination thereof.

12. The apron according to claim 1, wherein the heated hair care appliances comprise hair rollers, flat irons, curling irons, hair dryers, blow dryers, crimping irons, hot combs, electric shaver, pair of tongs, styling brushes, scalp massagers, or a combination thereof.

13. The apron according to claim 1, wherein the heat resistant pocket is positioned at a hip area of the torso.

14. The apron according to claim 1, wherein the heat resistant pocket is about 4 to 10 inches in width and about 6 to 12 inches in depth.

15. The apron according to claim 1, wherein the heat resistant pocket is stitched or sewn on the sides.

16. The apron according to claim 1, wherein the apron is a full apron, bib apron, waist apron, skirt, jumper, or a combination thereof.

17. A heat resistant receptacle comprising:
a heat resistant pocket attached to a front side of an apron,
wherein the apron covers the torso of a user,
wherein the heat resistant pocket comprises a fabric sheet and at least one heat resistant material for storing heated hair care appliances in the body panel,
wherein the heat resistant pocket has a square, rectangular, circular, triangular, or hexagonal shape,
wherein the heat resistant pocket comprises an open top portion and an open bottom portion,
wherein the open bottom portion comprises at least one zipper, at least one clasp, at least one button, or at least one fastener for closing the open bottom portion, and
wherein the heat resistant pocket comprises at least two side members securely attached to the body panel.

18. The heat resistant receptacle according to claim 17, wherein the heat resistant material protects the torso from heat and external burns from a heated hair care appliance.

19. The heat resistant receptacle according to claim 17, wherein the heat resistant material is scorch proof to about 500° F.

20. The heat resistant receptacle according to claim 17, wherein the heat resistant material comprises cotton or fibers treated with a flame retardant.
